(19) United States
(12) Patent Application Publication
(10) Pub. No.: US 2025/0036455 A1
(43) Pub. Date: Jan. 30, 2025

(54) ADJUSTED GROUP EXECUTION FRAMEWORK FOR MONOLITHIC APPLICATIONS WITH PREDICTIVE DIAGNOSTICS

(71) Applicant: VMware LLC, Palo Alto, CA (US)

(72) Inventors: Eduard Amirkhanyan, Yerevan (AM); Arnak Poghosyan, Yerevan (AM); Ashot Nshan Harutyunyan, Yerevan (AM); Ara Petrosyan, Yerevan (AM); Karlen Abrahamyan, Yerevan (AM)

(73) Assignee: VMware LLC, Palo Alto, CA (US)

(21) Appl. No.: 18/226,947

(22) Filed: Jul. 27, 2023

(51) Int. Cl. G06F 9/48; G06F 11/34

(52) U.S. Cl. CPC G06F 9/4843; G06F 11/3409; G06N 20/00

(57) ABSTRACT

The present disclosure is directed to an adjusted group execution framework (“AGEF”) that adjusts execution of a monolithic cloud application based on predictive diagnostics. The AGEF aids owners of monolithic applications with offloading existing overloaded tasks to other nodes in a cluster of server computers. The AGEF includes an executor that is responsible for running specified execution flows described in an instruction file and a built-in predictive diagnostic engine that is trained on metric data recorded in a historical time period during prior executions of the monolithic application. The predictive diagnostic system generate a performance value that reveals the state of the monolithic application in one of two categories, such as success or fail, or in multiple categories, such as high, moderator, or low performance.

### TECHNICAL FIELD

This disclosure is directed to a framework for predictive diagnostics of monolithic applications executing in a data center.

### BACKGROUND

Electronic computing has evolved from primitive, vacuum-tube-based computer systems to modern electronic computing systems in which large numbers of multi-processor computer systems are networked together with large-capacity data-storage devices and other electronic devices in data centers that provide enormous computational bandwidths and data-storage capacities. Data centers are made possible by advances in virtualization, computer networking, distributed operating systems, data-storage appliances, computer hardware, and software technologies. An increasing number of businesses, governments, and other organizations rent data processing services and data storage space as data center tenants. Data center tenants now conduct business and provide cloud services over the internet on software platforms that are maintained and run almost entirely in data centers, which reduces the cost of maintaining their own centralized computing networks and hosts.

Software platforms have traditionally been implemented as monolithic applications. A monolithic application is single-tiered software in which the user interface, application programming interfaces, data processing, and data access code are implemented in a single program that is run on a single platform. Each monolithic application is self-contained and runs independently from other applications. The design philosophy is that a monolithic application performs every step needed to complete a particular function or service requested by a client. Monolithic applications have a number of advantages: First, the monolithic architecture is the traditional way applications are built and this architecture does not require complex architectural patterns. As a result, monolithic applications are relatively simple to develop, test and debug. Second, startups often operate on a small budget. Monolithic applications are ideal for startups because the applications can be built by a small team of developers which keeps cost low. Third, deployment of a monolithic application is simple because the monolithic application is self-contained and has no dependencies on other application components.

By contrast, in recent years, the software landscape has evolved toward distributed applications with independent application components, called microservices. The distributed application runs in a microservices architecture composed of independently deployable microservices. Each microservice has its own logic and database and performs a single function or provides a single service. For example, a typical ecommerce application comprises microservices that interface with browsers, microservices that carry out transactions with banks, microservices that keep track of inventory, and microservices that control shipping of products to consumers. A typical ecommerce application may have thousands of microservices that enable seamless online purchasing experiences for customers. The microservice architecture has several advantages over a monolithic application. The microservices of the microservices architecture run independently. Each microservice can be separately developed, updated, deployed, and scaled up or down without affecting the other microservices. Software updates can be performed more frequently, with improved reliability, uptime, and performance.

Many application owners who provide online services via monolithic applications desire a move toward a distributed application architecture. However, the process of converting a large monolithic application to a distributed application is an expensive and time-consuming process. In addition, building a distributed application that provides the same services as an existing monolithic application is often encumbered by errors, which further complicates the process. Application owners seek an intermediate solution to the problem of building a distributed application to replace a monolithic application with a distributed application.

### SUMMARY

The present disclosure is directed to an adjusted group execution framework (“AGEF”) that adjusts execution of a monolithic cloud application based on predictive diagnostics. The AGEF aids owners of monolithic applications with offloading existing overloaded tasks to other nodes in a cluster of server computers, thereby achieving Cloud/SaaS specific requirements, such as the ability to provide more frequent changes versus the existing continuous integration and continuous delivery with minimal changes into the codebase of the monolith application. The AGEF includes an executor module that is responsible for running specified execution flows described in an instruction file and a built-in predictive diagnostic engine that is trained on key performance indicator (“KPI”) data recorded in a historical time period during prior executions of the monolithic application. The predictive diagnostic engine generates a performance value that reveals the state of the monolithic application in one of two categories, such as success or fail, or in multiple categories, such as high, moderator, or low performance. The AGEF deploys the predictive diagnostic engine to generate the performance value based on KPI metrics recorded in a current time period following AGEF intervention to reveal the state of the monolithic application after AGEF intervention. If the prediction of the monolithic application is success or high performance, the AGEF offloads tasks to nodes in a cluster.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example architecture of an adjusted group execution framework (“AGEF”).

FIGS. 14A-14G show different portions of an example instruction file.

FIG. 15 shows a plot of an example key performance indicator (“KPI”).

FIG. 16 shows an example of a monolithic application and a queue of tasks.

FIG. 17 shows an example cluster of nodes and the tasks of an application executed sequentially at each node and in parallel across the nodes.

FIG. 18 shows an example cluster of nodes and the tasks of an application executed in parallel at each node and sequentially across the nodes.

FIG. 19 shows an example cluster of nodes and the tasks of an application executed in parallel at each node and parallel across the nodes.

FIG. 20 shows an example cluster of nodes and the tasks of an application executed sequentially at each node and sequentially across the nodes.

FIG. 21 shows an example of computing normalized metric values in subintervals of a historical time period.

FIG. 22 shows example plots of normalized KPIs for three of N KPIs of an application.

FIG. 23 shows an example plot of three clusters of N-tuples.

FIG. 24 shows an example graphical user interface (“GUI”) of an operations manager of a data center that displays clusters of KPIs associated with an application on a display device.

FIG. 25 shows an example of performance labels added to N-tuples of a data frame to obtain a performance labeled data frame.

FIG. 26 shows an example GUI of an operations manager of a data center that enables a user to apply performance label to clusters of KPIs associated with an application on a display device.

FIG. 27 shows an example of classifying a runtime N-tuple based on clusters of N-tuples in a performance labeled data frame.

FIG. 28 shows an example of a decision tree technique used to generate a decision-tree model based on the labeled N-tuples of a performance labeled data frame.

FIG. 29A show an example small portion of a decision-tree model.

FIG. 29B shows examples of rules that correspond to paths in the decision-tree model of FIG. 29A.

### DETAILED DESCRIPTION

This disclosure is directed to an adjusted group execution framework (“AGEF”) that adjusts execution of a monolithic cloud application based on predictive diagnostics. In the first subsection, computer hardware, complex computational systems, and virtualization are described. The AGEF is described below in the second subsection.

### Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

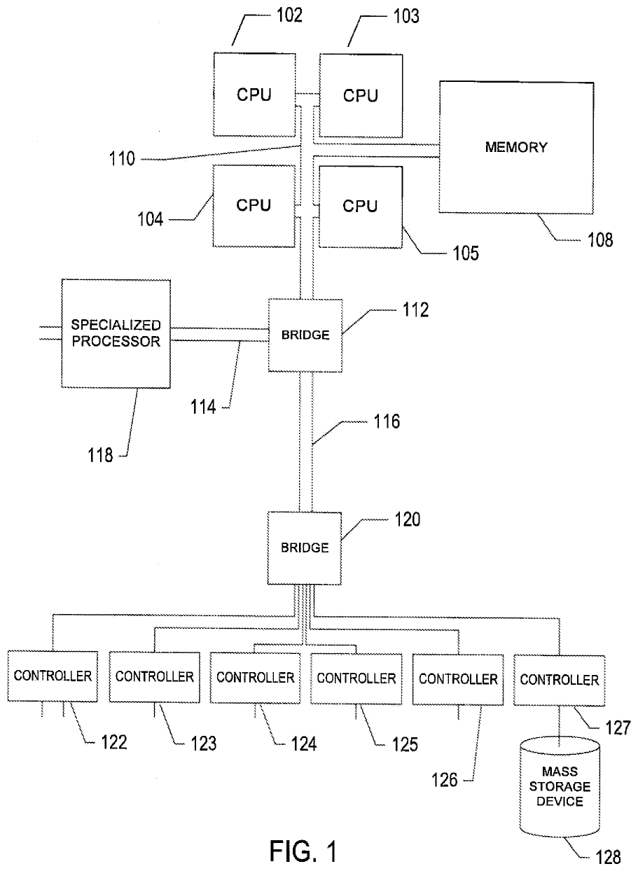

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

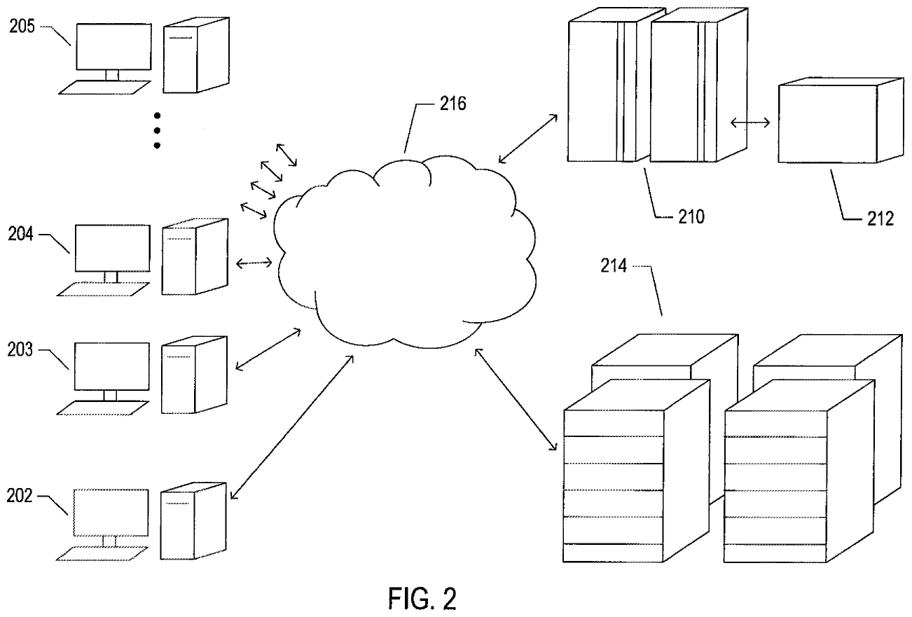

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

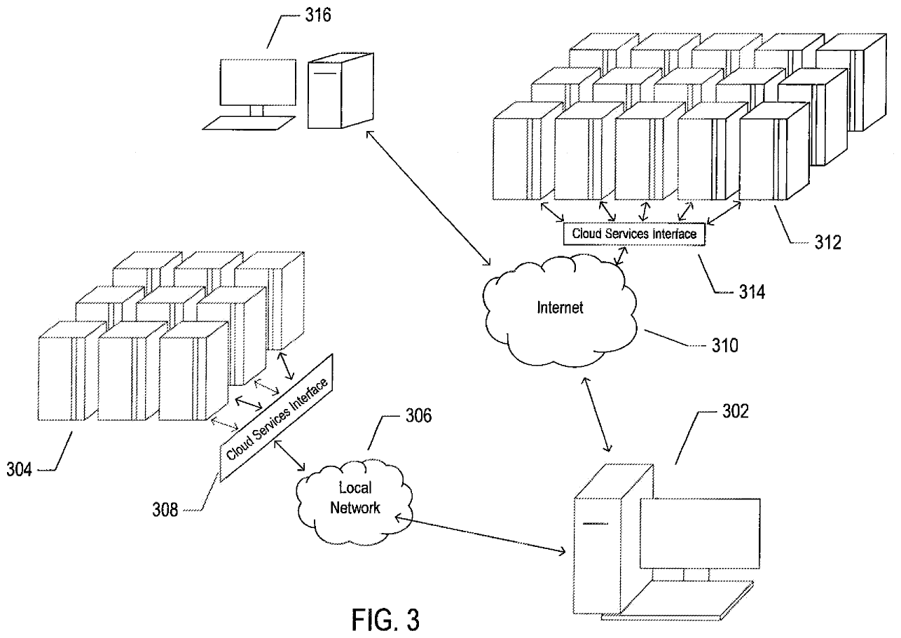

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

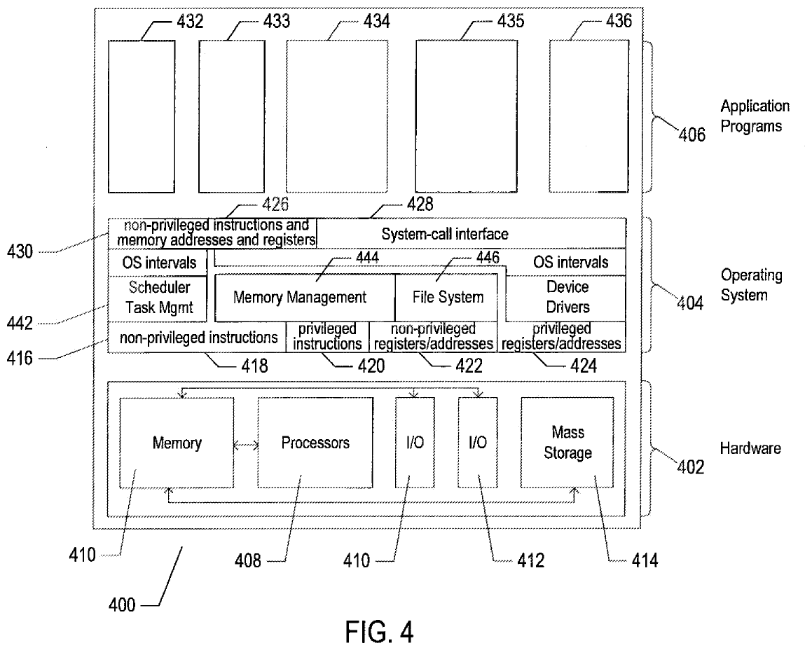

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

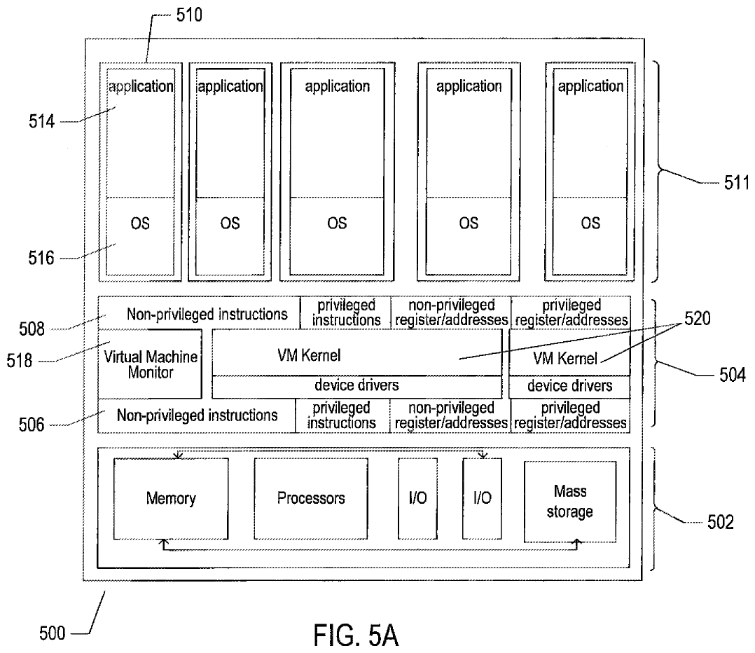

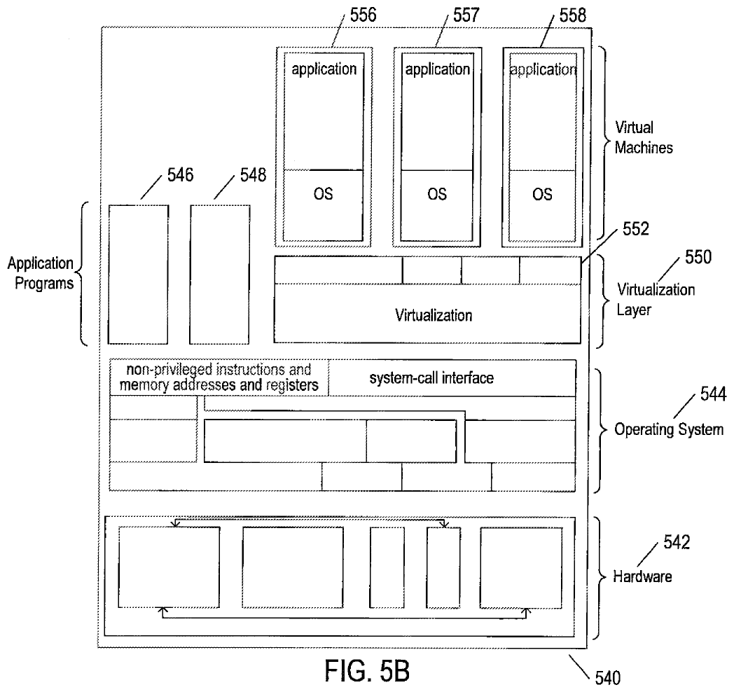

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

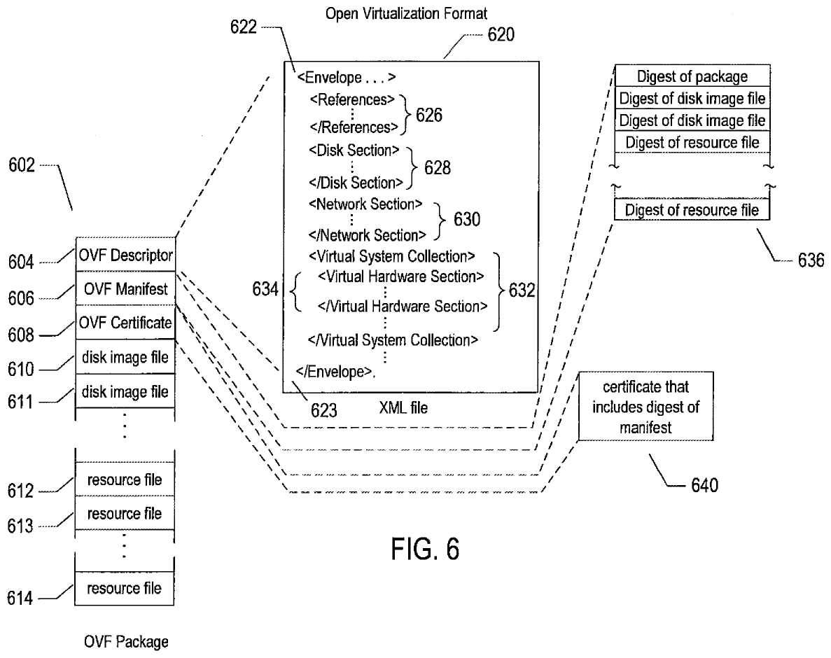

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing. XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VM and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

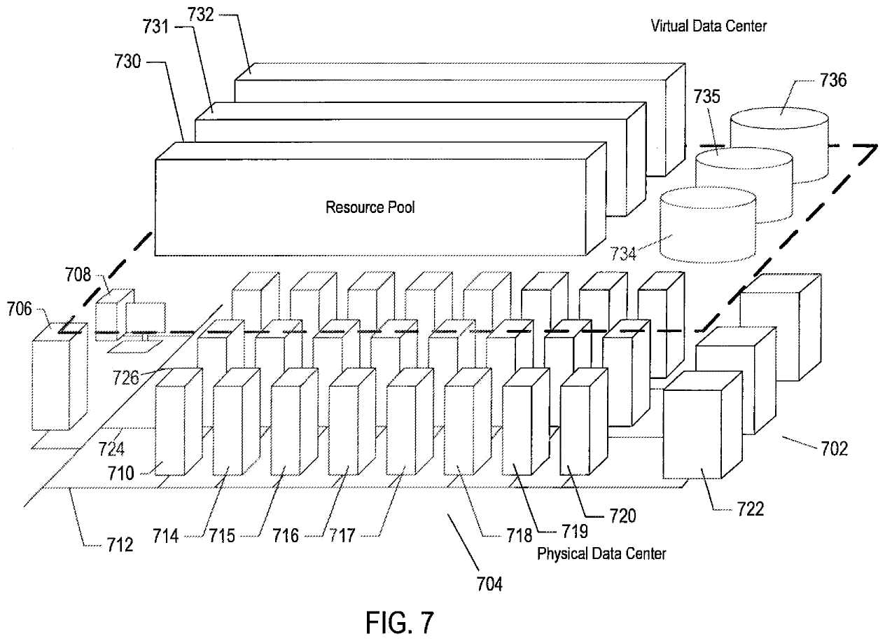

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

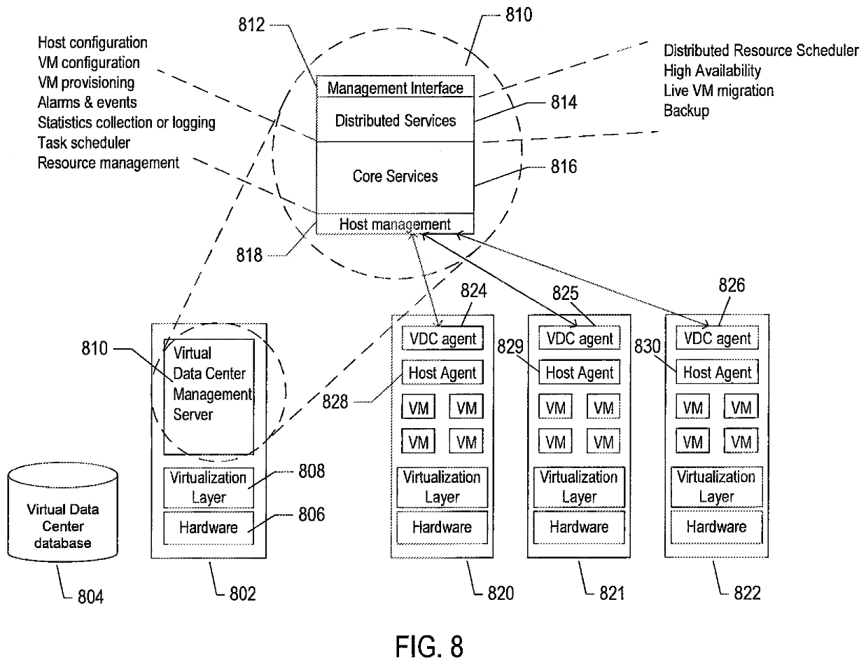

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

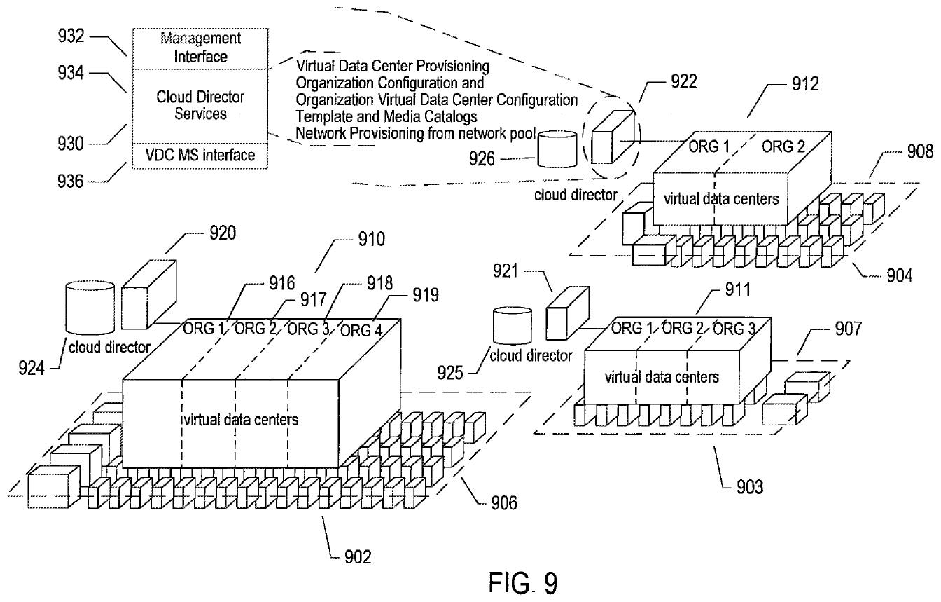

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

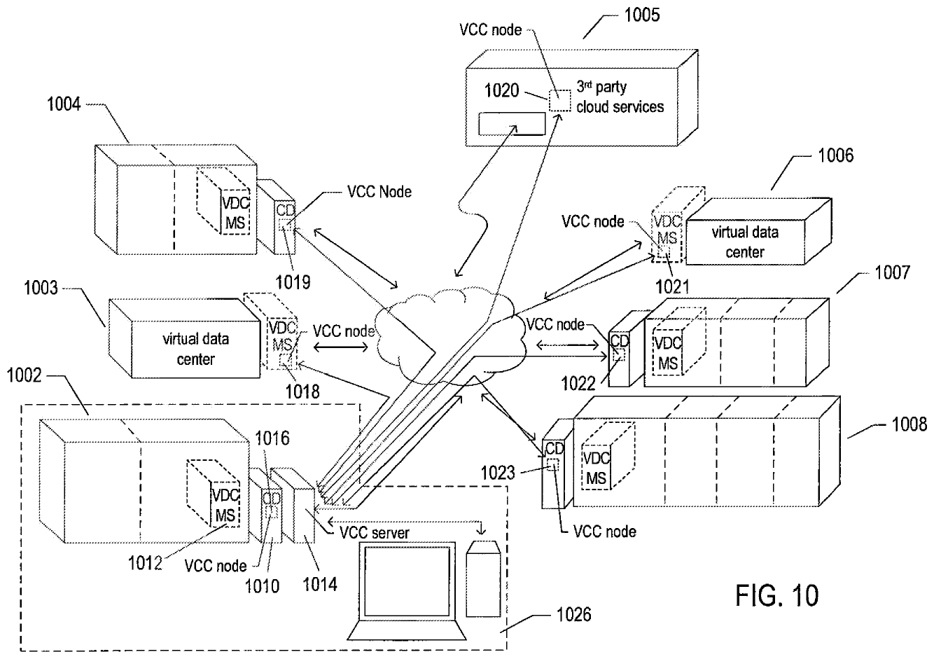

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

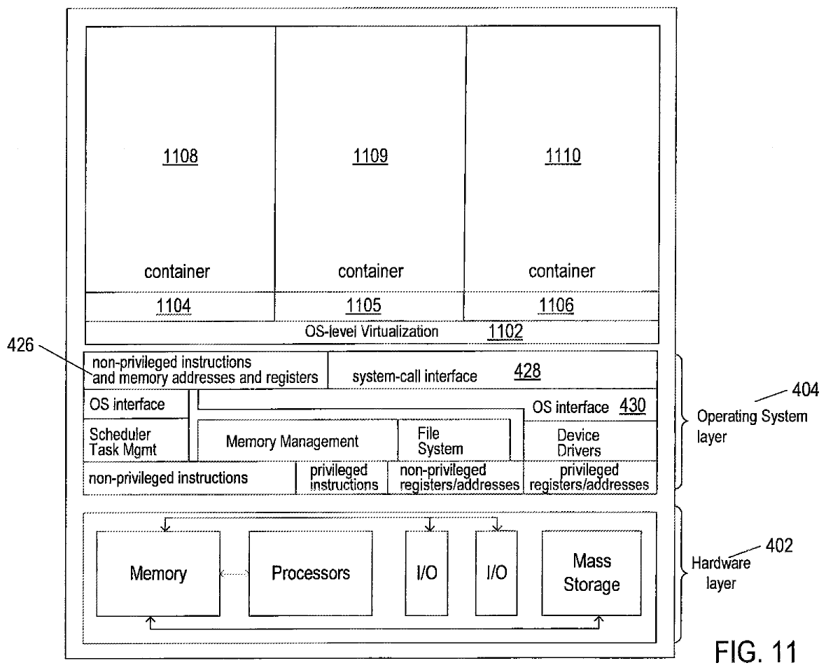

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

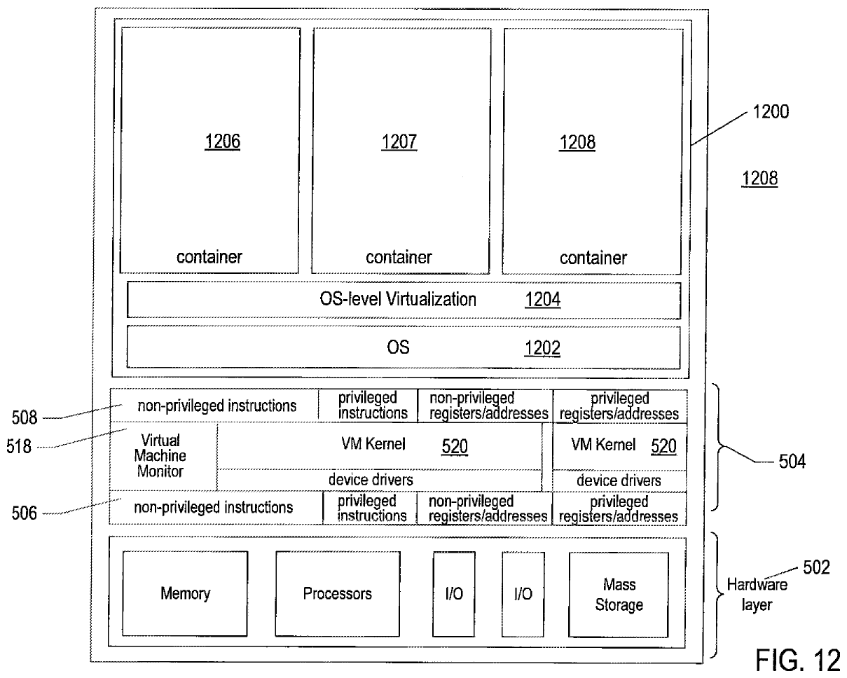

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Adjusted Group Execution Framework

This disclosure is directed to an adjusted group execution framework (“AGEF”) that adjusts execution of a monolithic application (“application”) based on predictive diagnostics. The monolithic application can be run in a VM, a container, or directly on a server computer (i.e., node) in a data center. The AGEF aids an owner of application with offloading overloaded tasks of the application to other nodes, such as other nodes in a cluster of server computers, and achieve Cloud/SaaS specific requirements with minimal or no changes to the code of the monolithic application. The AGEF gives system administrators the ability to make frequent changes to the application in contrast to the existing continuous integration and continuous delivery of monolithic applications. A training database of KPI metrics that represents the health status of the application is formed over a period of time preceding the execution of the AGEF. The AGEF uses the training database of KPI metrics to train a predictive machine learning diagnostic engine. The AGEF produces an aggregated status label that identifies the performance state of the application for post-execution periods. The status label indicates how the application behaved after AGEF intervention. In one implementation, the status label can be used to characterize the state of the application as a success or a failure. Alternatively, the status label can be used to characterize the state of application as low performance, medium performance, and high performance.

The AGEF provides the advantage of serving as an intermediate solution to the problem of converting the application to distributed application because the AGEF avoids changes to modules of the application. The AGEF also provides the ability to quickly correct bugs or defects in the application, bypasses the traditional software development process and necessary modifications in converting a monolithic application to a distributed application, and enables new service integrations on the already released and working application.

As various products are written in different languages and are based on different platforms, using numerous communication protocols for inter-component and inter-node communication, as well as different authentication mechanisms, the AGEF can implement interfaces that reuse existing authentication and communication mechanisms of the AGEF. The AGEF can receive instructions to execute new or already existing tasks on a single node or a cluster of nodes, either sequentially and/or in parallel. The AGEF can be used to define the order and dependencies between the executions and have execution flows based on the results.

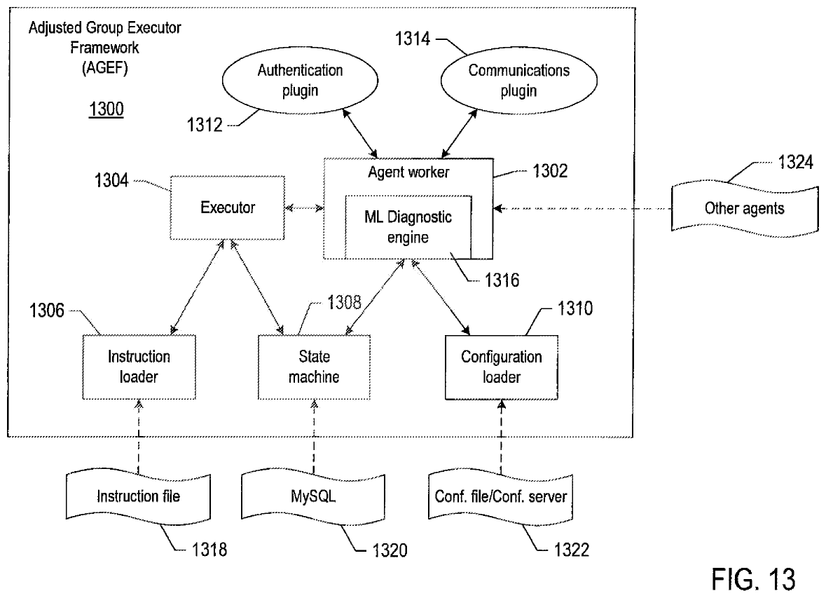

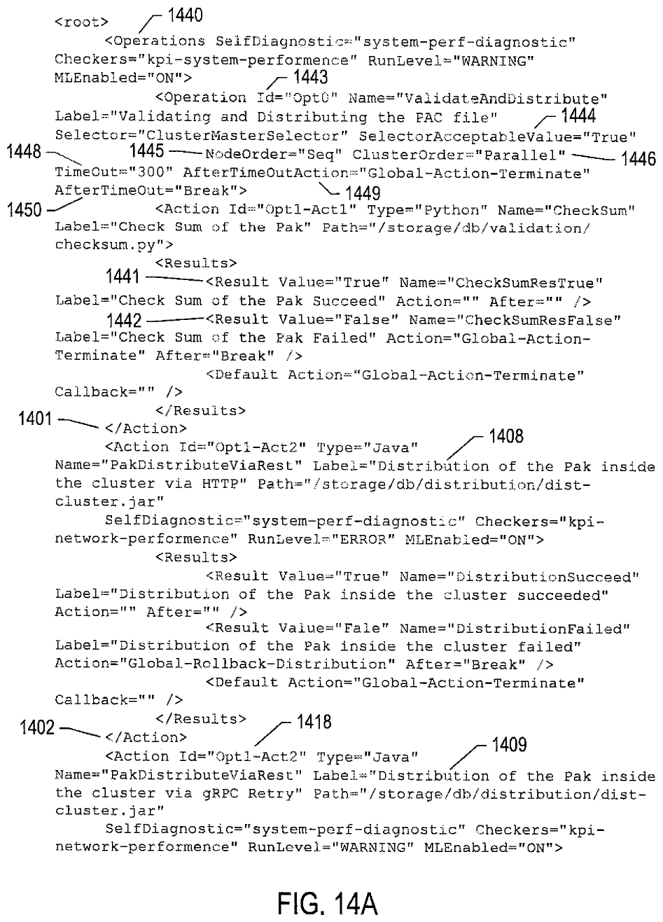

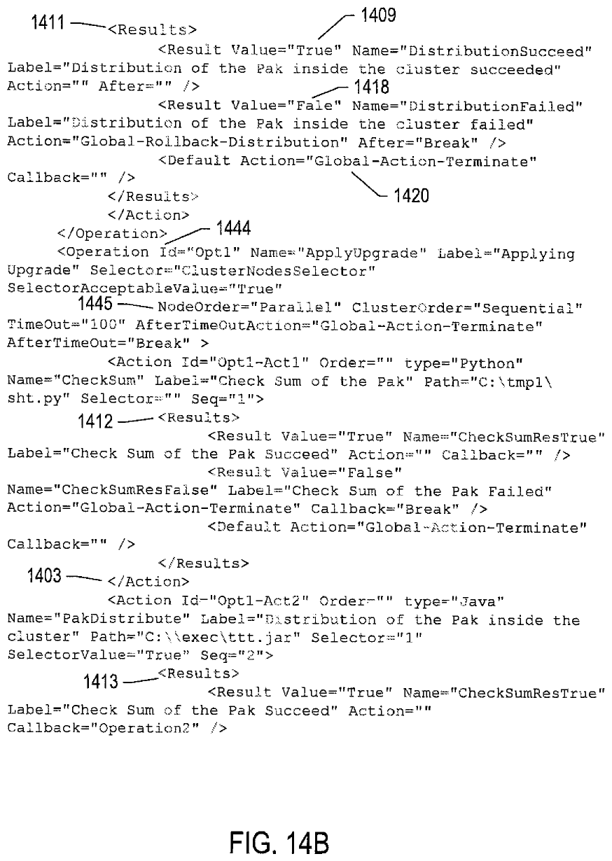

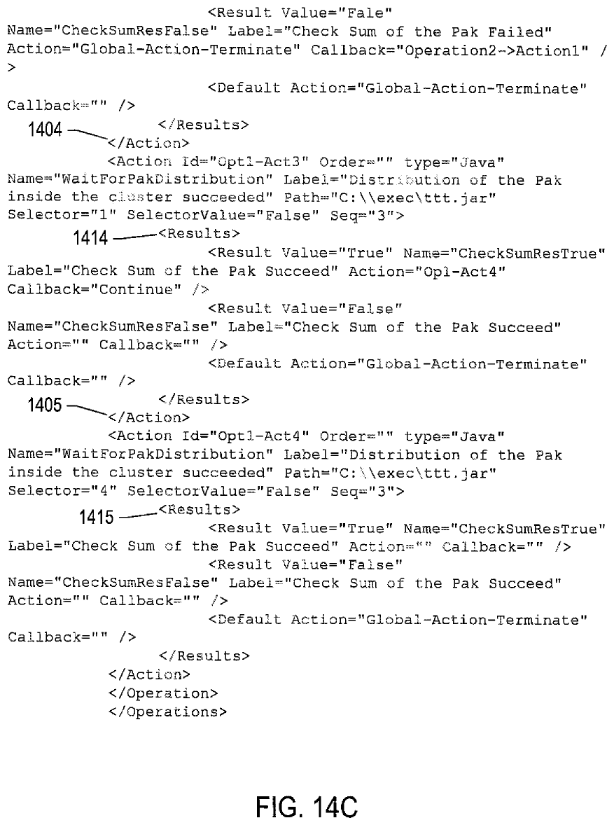

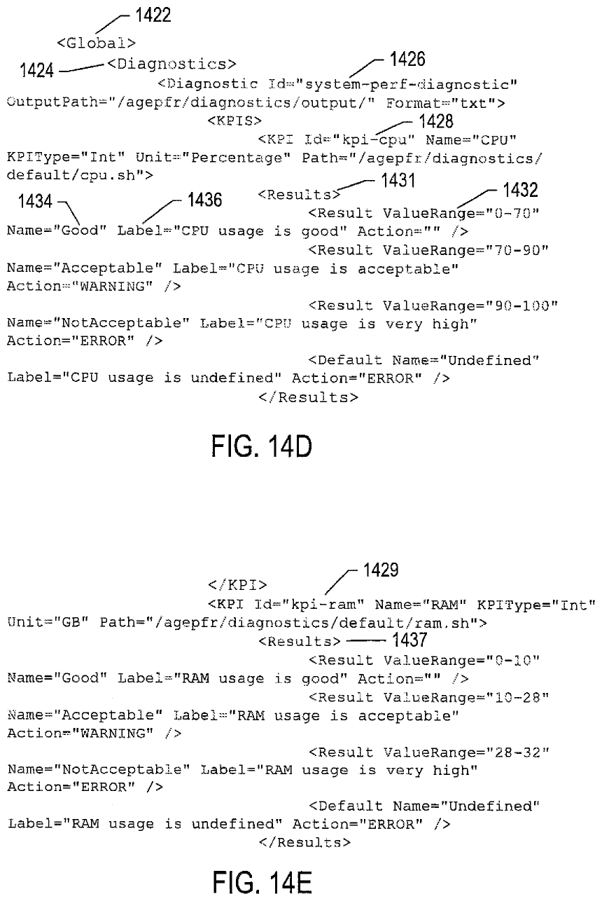

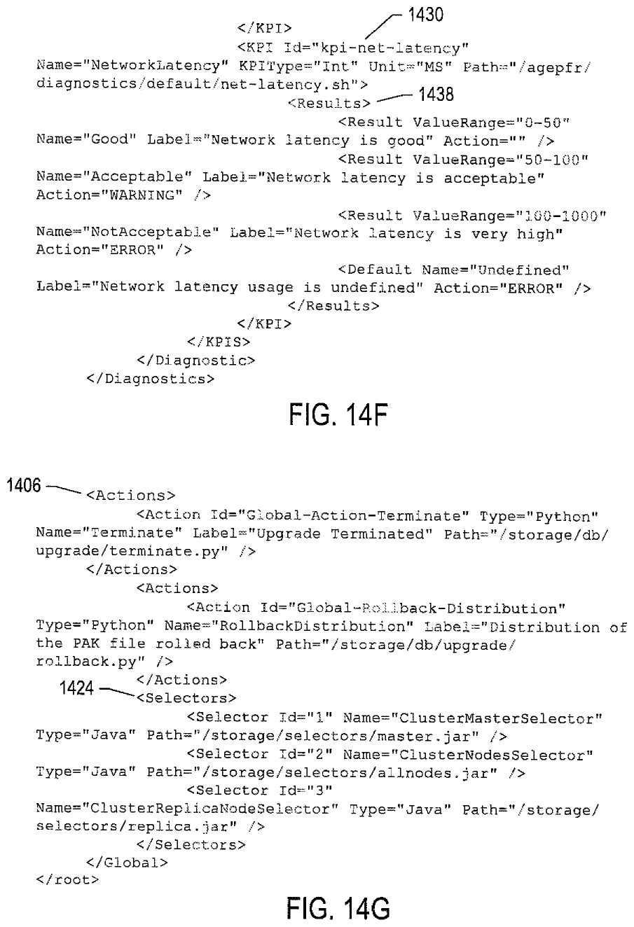

FIG. 13 shows an example architecture of an AGEF 1300. The AGEF 1300 includes an agent worker 1302, an executor 1304, an instruction loader 1306, a state machine 1308, a configuration loader 1310, an authentication plugin 1312, and a communications plugin 1314. The instruction loader 1306 checks and parses instruction file 1316. An example instruction filed is described below reference to FIGS. 14A-14G. State machine 1308 maintains a record of the state and status of operations and actions executed by the executor 1304 in a database using a standard query language (“SQL”), such as SQLLite or MySQL, in the event that the nodes the AGEF runs on is rebooted, the node can continue execution from the last point. The configuration loader 1310 maintains metadata in a configuration file and configuration server 1322. The agent worker 1302 includes a machine learning (“ML”) diagnostic engine 1316 that trains a model based on key performance indicator (“KPI”) metrics of the application, performs diagnostics, and predictions as described below. Executor 1304 is a module that is responsible for running the execution plan for the application in accordance with the actions and operations of the instruction file 1318. The agent worker 1302 is responsible for checking the status of the actions and operations performed by the executor 1304 and maintaining consistency between other agent workers 1324. The authentication plugin 1312 is an interface that determines which devices are authorized to exchange information with the AGEF 1300. The communications plugin 1314 is an interface for communication with other devices.

The instruction file 1316 comprises different elements identified as actions, results, global, selectors, diagnostics, and operations. FIGS. 14A-14G show different portions of an example instruction file. In this example, the instruction file is written in extensible markup language (“XML”) that contains elements executed by the executor 1304. The information file contains actions, such as actions 1401-1406, which are the smallest units that can be executed by the executor 1304. Each action includes a label that provides a user-readable message that describes an execution result that is shown in a graphical user interface (“GUI”). For example, actions 1401 and 1402 contain labels 1408 and 1409, respectively, that can be displayed in a GUI when the action is executed by the executor 1304. The information file contains results that compare the results of the actions to expected values or ranges and determine the next action to be performed by the executor 1304. For example, actions 1401-1406 contain the corresponding results 1410-1415. Each result also contains an action. For example, result 1411 gives a result value. In the case of matching a result, the executable mentioned in the result action attribute is executed by the executor 1304. The attribute is checked. The value of the after attribute can be empty, which means there is nothing for the executor 1304 to do and execution will go to a next action. On the other hand, when the value after the attribute is not empty, the action is performed by the executor 1304. Consider the results 1411 that are checked after the action with action id=“Opt1−Opt2” 1418. If the executor produces Result Value=“True” 1416 in response to executing the Action id=“Opt1−Act2” 1418, Name=“DistributionSucceeded” the Label=“Distribution of the Pak inside the cluster succeeded” Action=“ ” After=“ ” are left empty, which means there is nothing to do in response to this action and the executor 1304 proceeds to the next action. On the other hand, if the executor produces Result Value “False” 1418 in response to executing the Action id “Opt1−Act2” 1418, Name=“DistributionFailed” the Label=“Distribution of the Pak inside the cluster failed” Action=“Global-Rollback-Distribution” After=“break” are left executed by the executor 1304. If the Result Value is neither True or False, a default action 1420 is performed by the executor 1304.

FIGS. 14E-14G show elements that are performed under the global section 1420 of the instruction file. The global section declares the generic purpose actions, diagnostic KPIs, rules, and selectors. Selectors are specific kinds of actions. FIG. 14G shows an example of selectors 1422 for this information file. Before running any operation described below, the execution result of a selector is used to identify whether the operation should be executed on the deployment where agent worker 1302 is deployed. In this example, the diagnostics 1424 includes a diagnostics id 1426 followed by three examples of diagnostic KPIs kpi-cpu 1428, kpi-ram 1429, and kpi-net-latency 1430 that are used to monitor performance of the application at a moment in time. Each of the KPIs 1428-1430 includes a results section with value ranges for the corresponding KPIs. For example, in FIG. 14D, results 1431 gives CPU usage value ranges, names, and labels. A CPU usage in value range 1432 is given a name 1434 and a label 1436. The name 1434 and label 1436 can be displayed in the GUI giving a systems administrator an indication of CPU usage by the application. The results 1437 give value ranges, names, and labels for KPI memory and results 1438 give value ranges, names, and labels for KPI network latency. Implementations are not limited to the three example KPIs in FIGS. 14D-14F.

A KPI is a stream of time-series metric values that is generated by the application or operating system of the node the application runs on. Each KPI is recorded in a data storage device in spaced points in time called “time stamps.” A KPI is denoted by

$$\vec{x} = {( {x}_{i} )}_{i = 1}^{N} = {( x ( {t}_{i} ) )}_{i = 1}^{N}$$

where
N is the number of metric values in a sequence of metric values;
xᵢ=x(tᵢ) is a metric value;
tᵢ is a time stamp indicating when the metric value was generated in a time interval [t₁, t_{N}];
\vec{x}= [symbol] ^{N}; and
subscript i is a time stamp index i=1, . . . , N.

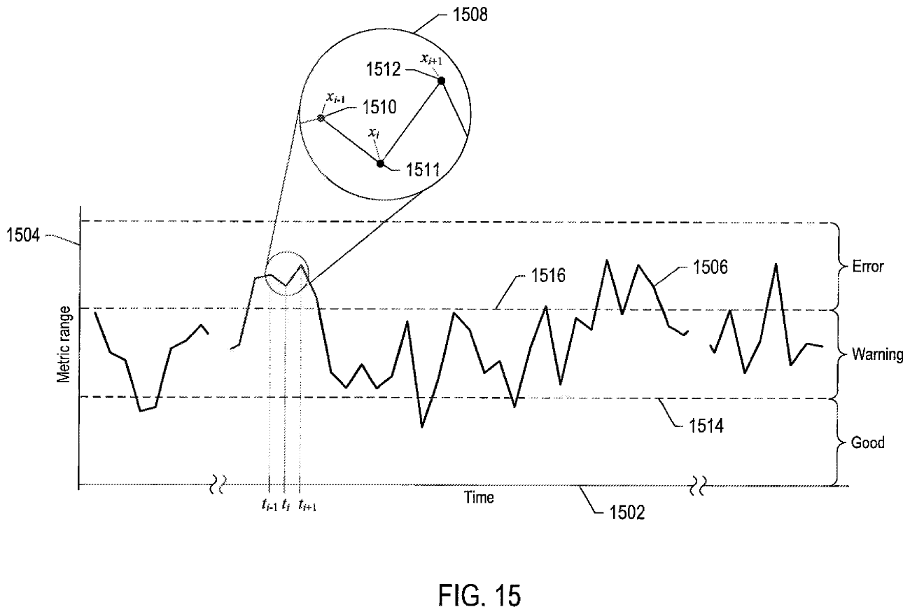

FIG. 15 shows a plot of an example KPI. Horizontal axis 1502 represents time. Vertical axis 1504 represents a range of metric values. Curve 1506 represents a metric as time-series data. FIG. 15 includes a magnified view 1508 of three consecutive metric values represented by points. Each point represents an amplitude of the metric at a corresponding time stamp. For example, points 1510-1512 represent consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁.

The example metric in FIG. 15 may represent usage of a physical or virtual resource. For example, the KPI may represent CPU usage of a core in a multicore processor of a server computer over time. The KPI may represent the amount of virtual memory assigned to a VM over time. The KPI may represent network throughput for a server computer the application is running on. The KPI may also represent application performance, such as CPU contention, response time to requests, and wait time for access to a resource of an application. A KPI for an online shopping application could be the number of shopping carts successfully closed per unit time by the application. A KPI for a website may be response times to customer requests. The KPI may be the number of input/outputs of a disk used by the application. The KPI may also be constructed from other KPIs, such as a sum of CPU usage, memory, and disk space. Other KPIs can be used to monitor performance of various services provided by the application, such as an error rate KPI. FIG. 15 also shows example thresholds that separate value ranges, such as CPU, memory, network latency value ranges described above with reference to results 1431, 1437, and 1438 of FIGS. 14D-14F.

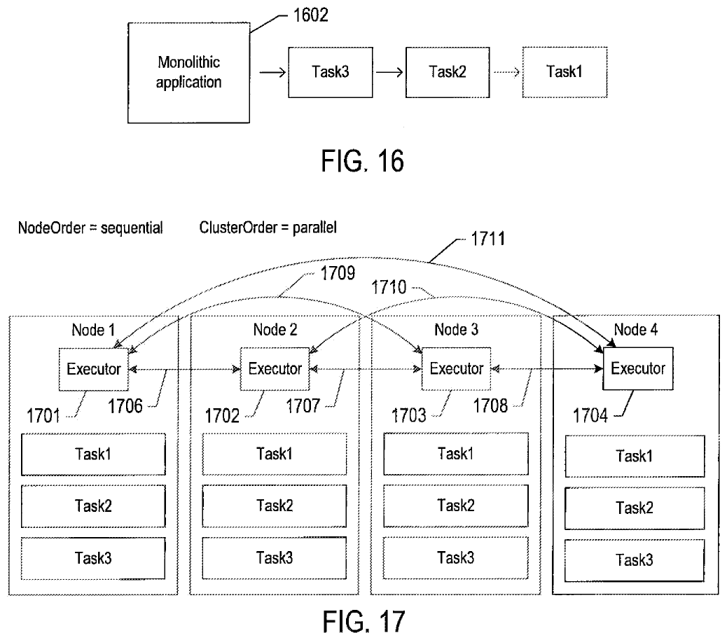

The information file 1318 contains for executing tasks of the application. A task is a unit of work or a unit of execution of the application. Examples of tasks include a thread or a processing step of the application. A task may also be regarded as a component of a job of the application. For example, the application may execute jobs, each of which is associated with a particular component of the application, and tasks are the steps of the jobs. FIG. 16 shows an example of a monolithic application 1602 and a queue of task identified as task1, task2, and task3. In a typical single node execution of the monolithic application 1602, the tasks are processed in sequential order. For example, task1 is processed before task2, which is processed before task 3.

By contrast, the operation of the information file 1318 can contain instructions for the executor 1304 to run the tasks of the application in a particular order and sequence in nodes of a cluster. The operation is the grouping unit for the actions. Each operation has a selector attribute and selector acceptable value. If the execution result value of a selector matches the selector acceptable value on a given deployment of the tasks, the operation becomes marked for the execution by executor 1304 according to a selected node order and cluster order. The node order can be sequential or parallel and the cluster order can be sequential or parallel. For example, in FIG. 14A, under operations 1440, result value 1441 is set to “True” and result value 1442 is set to “False.” Under Operation Id 1443 assigned “Opt0” with selected acceptable value 1444 set to “True,” the node order 1445 is assigned “sequential” and the cluster order 1443 is assigned “parallel.” Alternatively, in FIG. 14B, the information file under Operation Id 1442 is assigned “Opt1”, the node order 1445 is assigned “parallel” and the cluster order 1446 is assigned “sequential.”

The cluster order defines the execution order of tasks by nodes of a cluster. When the cluster order is “sequential,” the cluster nodes sequentially execute the tasks assigned to the nodes. In other words, when a node completes execution of assigned tasks, the next node begins execution of a next task. Alternatively, when the cluster order is “parallel,” the execution of tasks between nodes of the cluster is performed in parallel. If any of the nodes forming a cluster for an operation become not reachable for the communication, a timeout counter begins. When the timeout counter reaches a threshold, such as timeout counter 1448 in FIG. 14A, a timeout action 1449 is executed, which in this example is “Global-Action-Terminate.” If the after timeout value 1450 is set to “Break,” the execution of the task stops, otherwise, control flows to the next operation.

The node order defines the order execution of tasks within each node. When the node order is “sequential.” the tasks assigned to each node are performed sequentially. For example, after the first task is completed at a node, the next task begins at the node. When the node order is “parallel,” the task are run in parallel at each node. If the operation is defined in a clustered mode (e.g. cluster order is not empty), each node waits for node execution to reach the start of an operation then execute tasks in a given order. Each node contains a local execution status. However, the execution of tasks for each node continues to the next operation only if all the nodes have finished the previous cluster operation.

When tasks are distributed across nodes of a cluster, the executor of the AGEF is created on the nodes of the cluster to ensure execution of the workflow of the tasks at each node and across the cluster. The executors created at the nodes of the cluster share information about the progress of tasks executed at each cluster to manage the execution order of tasks inside each node and across the nodes of the cluster.

FIG. 17 shows an example cluster of four nodes and the tasks of the application 1602 executed sequentially at each node and in parallel across the nodes. The cluster is composed of four nodes denoted by node 1, node 2, node 3, and node 4. Each node includes a separate instance of the executor 1701-1704. In this example, the node order is set to “sequential,” and the cluster order is set to “parallel.” In other words, each node executes the same three tasks of application 1602 sequentially at each node and in parallel across the nodes of the cluster. The executors 1704-1707 ensure that the nodes execute the tasks task1, task2, and task3 in the same sequential order. The executors 1704-1707 of the nodes communicate as indicated by directional arrows 1706-1711 to ensure that tasks are executed in parallel across the nodes. For example, the executors 1704-1707 ensure that task1 is completed in parallel at the nodes before the nodes proceed to execute task2.

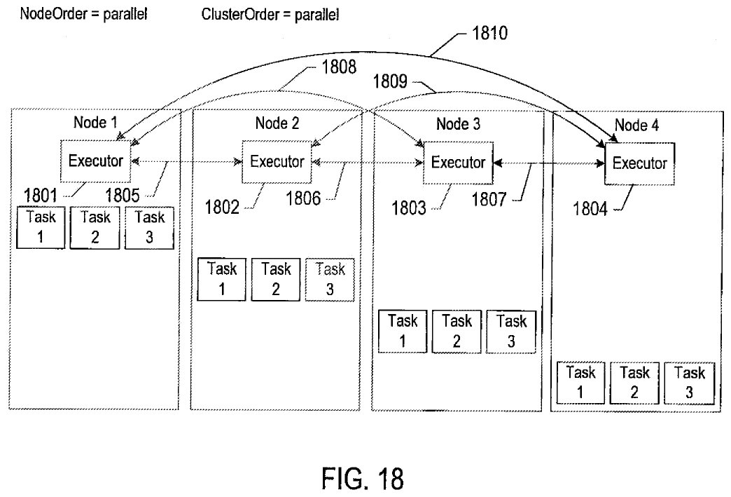

FIG. 18 shows the example cluster of four nodes and the tasks of the application 1602 executed in parallel at each node and sequentially across the nodes. Each node includes a separate instance of the executor 1801-1804. In this example, the node order is set to “parallel.” and the cluster order is set to “sequential.” In other words, each node executes the same three tasks of the application 1602 in parallel and the three tasks are executed sequentially across the nodes of the cluster. For example, the executor 1801 ensures that node 1 executes task1, task2, and task3 in parallel (i.e., at essentially the same time), the executor 1802 ensures that node 2 executes task1, task2, and task3 in parallel, the executor 1803 ensures that node 3 executes task1, task2, and task3 in parallel, and executor 1804 ensures that node 4 executes task1, task2, and task3 in parallel. The executors 1801-1804 communicate as indicated by directional arrows 1805-1810 to ensure that the tasks are also executed sequentially across the nodes. For example, the executor 1801 notifies executor 1802 when execution of task1, task2, and task3 in parallel is completed. The executor 1802 then immediately starts execution of task1, task2, and task 3 in parallel at node 2. Node 3 wait until processing of the tasks is completed before processing task1, task2, and task 3.

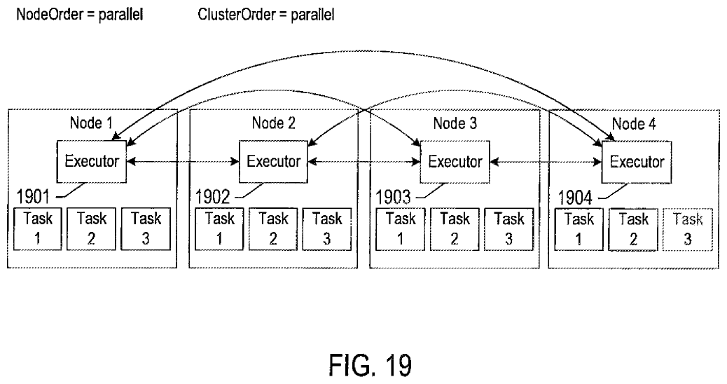

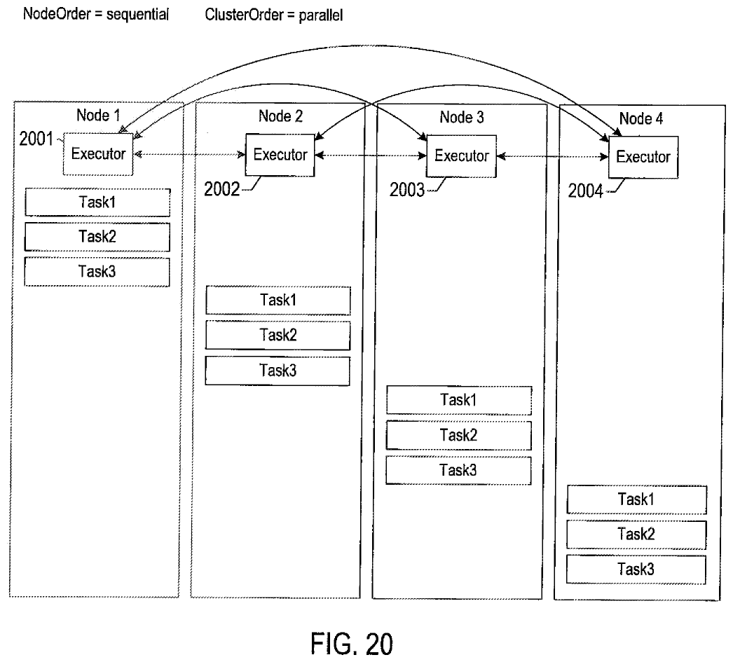

The operations are not limited to node order being sequential and cluster order being parallel or node order being parallel and cluster order being sequential. In another implementation, node order and cluster order can be parallel. FIG. 19 shows the example cluster of four nodes and the tasks of the application 1602 executed in parallel at each node and parallel across the nodes. The executors 1901-1904 ensure that task1, task2, and task3 are executed in parallel at each node and in parallel across the cluster. FIG. 20 shows the cluster of four nodes and the tasks of the application 1602 executed sequentially at each node and sequentially across the nodes. The executors 2001-2004 ensure that task1, task2, and task3 are executed sequentially at each node and sequentially across the cluster and tasks are completed on one node before the tasks are started on a next node.

Note that executors of a cluster also use barriers to ensure that if one of the nodes completes execution of a task assigned to the node earlier than expected, the node waits until the other nodes catch up before the node continues executing. Barriers ensure that previous tasks have been completed on the other nodes before subsequent tasks are executed on the nodes. For example, in FIG. 17 the executors 1701-1704 exchange time of completion information so that if one of the nodes completes a task in the queue before the other nodes, the node waits to receive confirmation from the other nodes that the other nodes have completed execution of the same task before processing the next task.

Suppose the application owner wants to run certain tasks on certain nodes only and does not want to run the tasks on the other nodes of the cluster. The application owner can define scope variables in the information file 1318 that identify which of the nodes can be used to execute tasks. The executor uses the scope variables to run the tasks on the nodes identified in the scope variables and the other nodes would not be used to run the tasks.

For each action or operation of tasks of the application defined in the information file, KPI metrics are collected for a period of time (i.e., a historical time period) to form a training data set that is used by the ML diagnostic engine 1316 to train ML models that are used to predict performance of an action or operation before that the action or operation modifies the application. If prediction meets the user satisfaction state, such as success or high performance, the action runs. Otherwise, the ML models can be used to diagnose the problem and determine a recommendation for improving performance of the application.

For each KPI associated with an action or operation of the tasks of the application as described above with reference to FIGS. 17-19, the ML diagnostic engine 1316 partitions the historical time period into J non-overlapping subintervals denoted by Iⱼ, where j=1, . . . , J. The ML diagnostic engine 1316 computes an average of the metric values of the KPI in each subinterval to obtain average metric values over each subinterval:

$${y}_{j} = \frac{1}{c ( {I}_{j} )} {\sum }_{{x}_{i} ∈ {I}_{j}} {x}_{i} \qquad ( 1 )$$

The J average metric values are normalized to obtain normalized metric values for each of subintervals:

$${m}_{j} = \frac{{y}_{j} - {y}_{min}}{{y}_{max} - {y}_{min}} \qquad ( 2 )$$

where
yₘᵢₙ is the minimum average metric value of the subintervals; and
yₘₐₓ is the maximum average metric value of the subintervals.

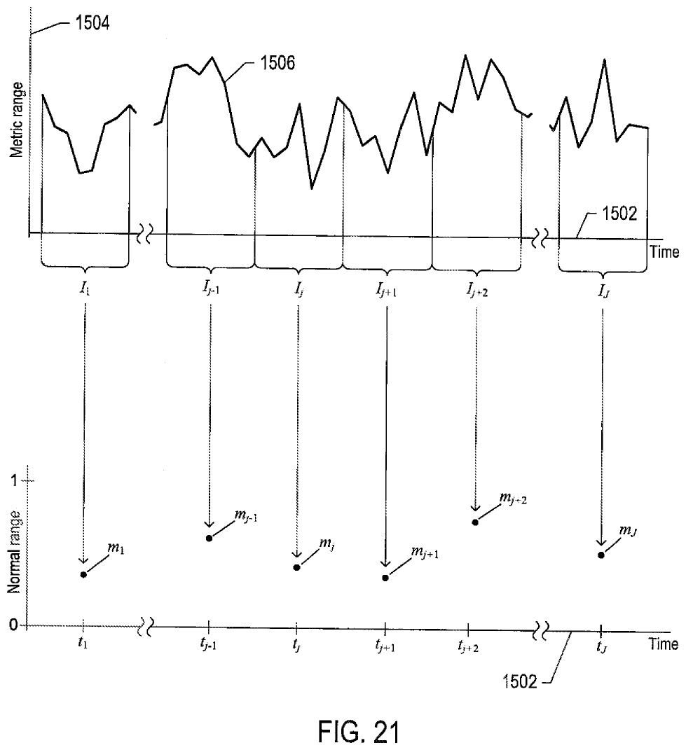

FIG. 21 shows an example of computing normalized metric values in J subintervals of the historical time period of the example KPI shown in FIG. 15. The historical time period is partitioned into subintervals I₁, . . . , I_{J}. The metric values within each subinterval are averaged and normalized to obtain corresponding normalized metric values m₁, . . . , m_{J}. FIG. 21 includes a plot of the normalized metric values m₁, . . . , m_{J} that correspond to time stamps t₁, . . . , t_{J} located at the midpoints of the subintervals I₁, . . . , I_{J}. Because each of the normalized metric values represents metric values in the corresponding subinterval, the metric values may be in any of the one or more value ranges associated with the metric, such as the result value ranges for CPU, memory, and network latency in FIGS. 14D-14F.

Normalized metric values are computed for each of the N KPIs of the application over the historical time period, where N is a positive integer. The N normalized metric values of the different KPIs at each of the time stamps t₁, . . . , t_{J} are denoted by mⱼₙ, where the second subscript n is a KPI index n=1, . . . , N. The normalized metrics values that correspond to the same time stamps represent N-tuples in an N-dimensional space of KPIs.

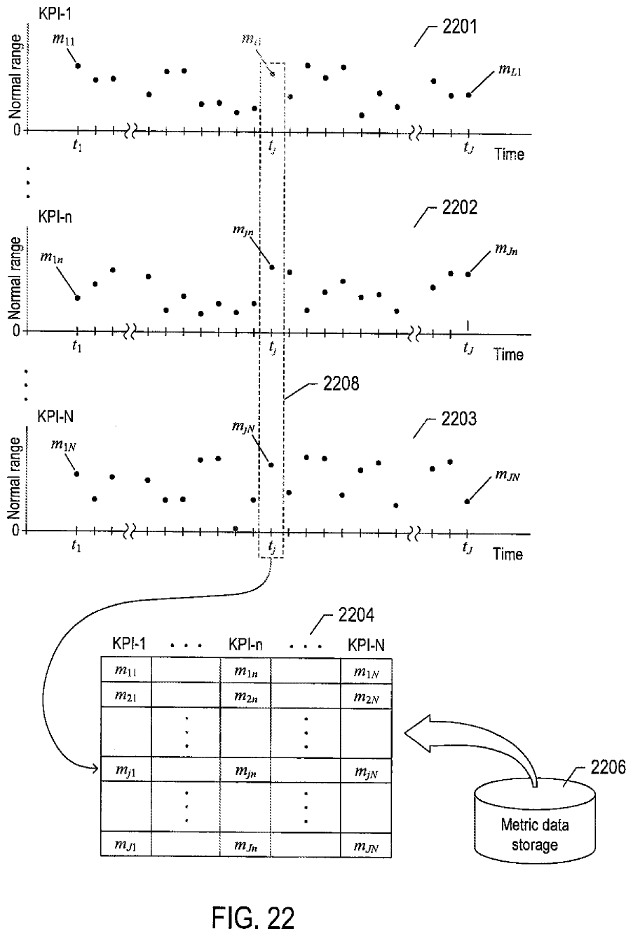

FIG. 22 shows example plots of normalized KPIs for three of N KPIs of the application denoted by KPI-1, . . . , KPI-N. Plot 2201 shows the normalized metric values of KPI-1. Plot 2202 shows the normalized metric values of KPI-n. Plot 2203 shows the normalized metric values of KPI-N. In this example, the normalized metric values are aligned with the midpoint time stamps t₁, . . . , t_{J} of the subintervals I₁, . . . , I_{J}. The normalized metric values of the N KPIs are recorded in a data frame 2204 of a normalized metrics database that is stored in a data storage device 2206. Dashed rectangle 2208 identifies normalized metrics values that correspond to the same time stamp tⱼ and form an N-tuple (mⱼ₁, . . . , mⱼₙ, . . . , m_{jN}) in an N-dimensional space of the KPIs.

The N-tuples represent the average behavior of the application in each subinterval of the historical time period. The N-tuples are labeled according to performance characteristics of the application. For example, the N-tuples may be labeled as a success or a failure. The N-tuples that correspond to success are assumed to form a first cluster of N-tuples that lies generally in the same part of the N-dimensional space, and the N-tuples that correspond to a failure are assumed to form a second cluster that lies generally in a different part of the N-dimensional space. Alternatively, the N-tuples may be labeled as low performance, medium performance, or high performance with the N-tuples that correspond to low performance lying in a first cluster of a first part of the N-dimensional space, the N-tuples that correspond to medium performance lying in a second cluster of a second part of the N-dimensional space, and the N-tuples that correspond to high performance lying in a third cluster of a third part of the N-dimensional space.

In one implementation, K-means clustering can be used to separate the N-tuples into different clusters. For example, when the N-tuples are separated by success or failure K equals two. Alternatively, when the N-tuples are separated by low, medium, and high performance K equals three. Let (Eⱼ)ⱼ₌₁^{J} denote a set of N-tuples where Eⱼ=(mⱼ₁, . . . , mⱼₙ, . . . , m_{jN}). K-means clustering is an iterative process of partitioning the N-tuples into K clusters such that each of the N-tuple belongs to one cluster with the closest cluster center. K-means clustering begins with the full J feature vectors and K cluster centers denoted by {Aᵣ}ᵣ₌₁^{K}, where Aᵣ is an N-dimensional cluster center. Each N-tuple is assigned to one of the K clusters defined by:

$${C}_{k}^{( h )} = \{ {E}_{i} : \vert {E}_{i} - {A}_{k}^{( h )} \vert \leq \vert {E}_{i} - {A}_{r}^{( h )} \vert ∀ i , 1 \leq r \leq K \} \qquad ( 3 )$$

where
Cₖ^{(m)} is the k-th cluster k=1, 2, . . . , K; and
superscript h is an iteration index h=1, 2, 3, . . . .
   The cluster center \vec{q}ₖ^{(h)} is the mean location of the N-tuples in the k-th cluster. A next cluster center is computed at each iteration by:

$${A}_{k}^{( h + 1 )} = \frac{1}{\vert {C}_{k}^{( h )} \vert} {\sum }_{{E}_{i} ∈ {C}_{k}^{( h )}} {E}_{i} \qquad ( 4 )$$

where |Cₖ^{(h)}| is the number of data points in the k-th cluster.

For each iteration h, Equation (3) is used to determine the cluster Cₖ^{(h)} each N-tuple belongs to followed by recomputing the coordinate location of each cluster center according to Equation (4). The computational operations represented by Equations (3) and (4) are repeated for each iteration, h, until the N-tuples in each of the K clusters do not change. The resulting clusters of event types are represented by:

$${C}_{k} = {\{ {E}_{p} \}}_{p = 1}^{{j}_{k}} \qquad ( 5 )$$

where Jₖ is the number of N-tuples (i.e., log messages with the same even type) in the cluster Cₖ.

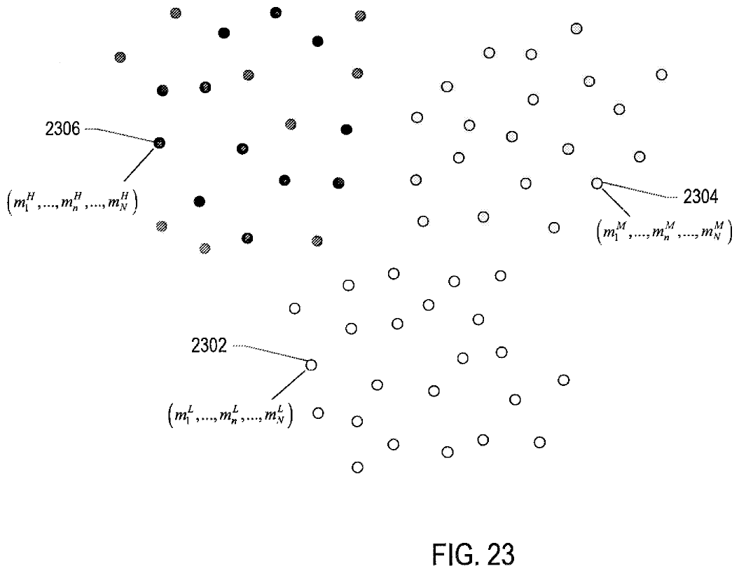

FIG. 23 shows an example plot of three clusters of N-tuples. Although each point represents an N-tuple in an N-dimensional space, for the sake of simplicity, the points are represented in two dimensions. The points are illustrated in three different shades to represent the three different clusters. The N-tuples in each cluster are tagged with a label that designates the performance level of the application. For example, open points, such as point 2302, represent a set of N-tuples that correspond to low performance of the application. Gray shaded points, such as point 2304, represent a set of N-tuples that correspond to medium performance of the application. Solid points, such as point 2306, represent a set of N-tuples that correspond to high performance of the application.

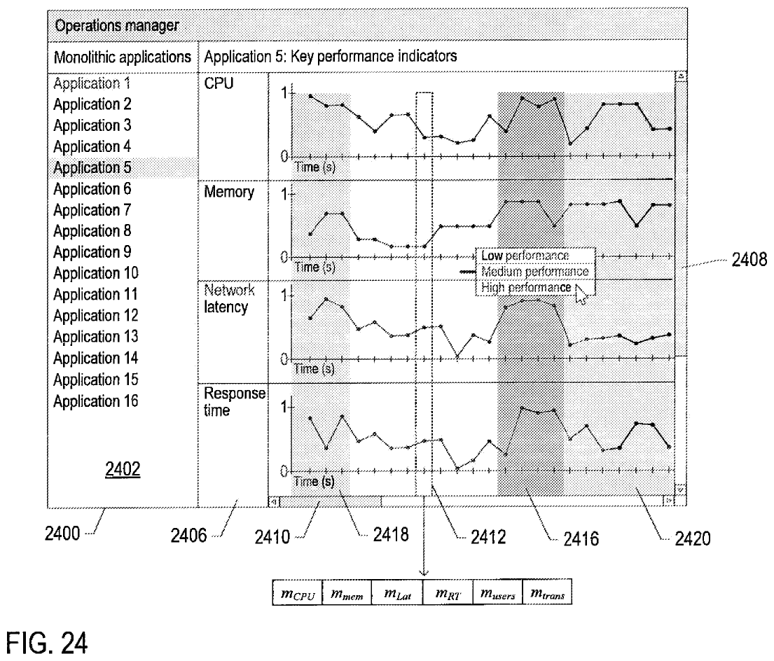

The performance levels can be assigned to the clusters by a user, such as the application owner or a systems administrator, using a GUI. FIG. 24 shows an example GUI 2400 of an operations manager of the data center that displays clusters of the KPIs associated with an application on a display device. Pane 2402 displays a list of monolithic applications running in the data center. In this example, a user has selected “Application 5” as indicated by shaded region 2404. In response to selecting Application 5, the GUI displays the KPIs recorded in a historical time period in pane 2406 after clustering. The KPIs of the application include CPU, memory, network latency, response time, number of users, and number of completed transactions. Pane 2406 includes scroll bars 2408 and 2410 that enable the user scroll up, down, and sideways to view the normalized metric values of the KPIs recorded in the historical time period. In this example, shading is used to identify the three different clusters of N-tuples determined using clustering, such as K-means clustering. Dashed rectangle 2412 identifies normalized metric values that form an N-tuple composed of CPU, memory, network latency (“Lat”), response time (“RT”), number of users (“users”), and number of transactions (“trans”). The metric values that belong to a first cluster are identified by light shading in region 2414. The metric values that belong to a second cluster are identified by dark shading in region 2416. The metric values that belong to a third cluster are identified by medium shading in regions 2418 and 2420. In this example, a user labels the N-tuples of each cluster by hovering the cursor over a region, which creates a popup window, such as popup window 2422, that displays options for labeling the metric values in the cluster identified by light shading. The user can then select a label for the metric values, such as low performance, medium performance, and high performance. In FIG. 24, the user has selected “high performance” for all N-tuples in the cluster identified by light shading. After a user has labeled the N-tuples of one cluster, the label is not available to label the remaining two clusters. The user then hovers the cursor over a different shaded region and selects a “medium performance” or a “low performance” label for all N-tuples in the cluster identified that corresponds to the shaded region. For example, the user may next hover the cursor over dark shaded region 2416 and select “low performance” for all N-tuples in the cluster identified by dark shading.

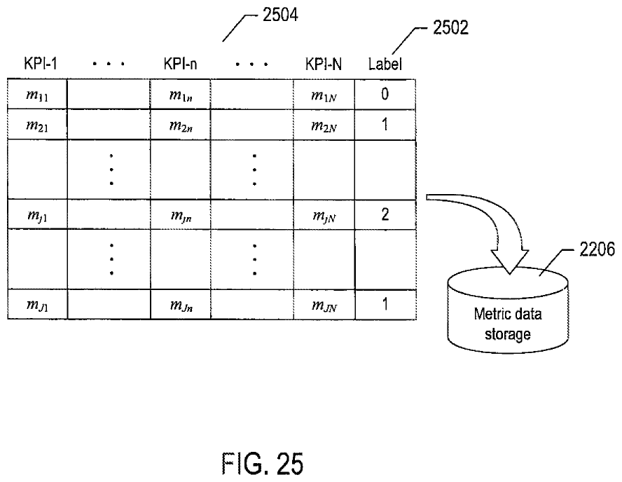

The labels selected by the user via the GUI are applied to the N-tuples of the data frame in the KPI database for the selected application. FIG. 25 shows an example of performance labels 2502 added to the N-tuples of the data frame 2204, shown in FIG. 22, to obtain a performance labeled data frame 2504 stored in a labeled KPI database for the selected application. In this example, label “0” corresponds to the user-selected “low performance” label in the GUI, label “1” corresponds to the user-selected “medium performance” label in the GUI, and label “2” corresponds to the user-selected “high performance” label in the GUI.

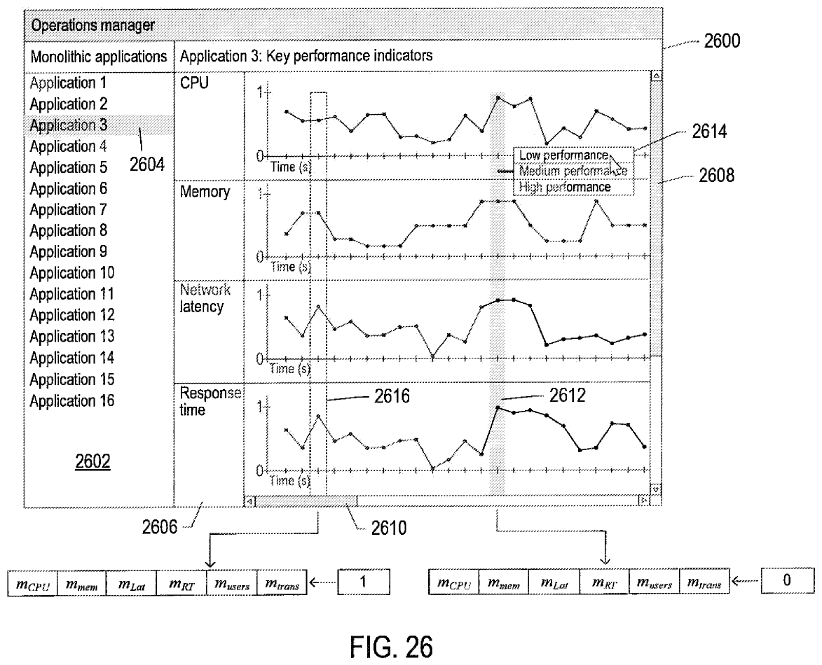

In another implementation, rather than performing automated clustering, a user can cluster the N-tuples and assign a performance label to the N-tuples via a GUI. FIG. 26 shows an example GUI 2600 of an operations manager of the data center that enables of user to apply performance labels to clusters of the KPIs associated with an application on a display device. Pane 2602 displays a list of monolithic applications running in the data center. In this example, a user has selected “Application 3” as indicated by shaded region 2604. In response to selecting Application 3, the GUI displays the KPIs recorded in a historical time period in pane 2606 after clustering. Pane 2606 includes scroll bars 2608 and 2610 that enable the user to scroll up, down, and sideways to view the normalized metric values of the KPIs recorded in the historical time period. In this example, a user creates clusters by individually labeling the N-tuples. For example, the user hovers the cursor over each column of N-tuples, such as column of N-tuples 2612, which creates a popup window, such as popup window 2614, that displays options for labeling the N-tuple as low, medium, or high performance. In FIG. 26, the user has selected “low performance,” which adds corresponding label “0” to the N-tuple in the KPI data frame and adds the N-tuple 2614 to a cluster of N-tuples identified as low performance. The remaining N-tuples can be added to clusters and labeled in the same manner. For example, the user may next label the N-tuple identified by dashed rectangle 2616 as “medium performance,” which labels the N-tuple in the KPI database with “1.”

The ML diagnostics engine 1316 constructs a model that uses K-nearest neighbor machine learning to predict the performance state of the application based on the clusters of labeled N-tuples described above. The ML diagnostics engine 1316 receives telemetry KPI metric values for the KPIs KPI-1, . . . , KPI-N in a current time window. The KPI metric values associated with each metric are averaged and normalized to obtain runtime N-tuple (m₁^{rt}, . . . , mₙ^{rt}, . . . , m_{N}^{rt}) as described above with reference to Equations (1) and (2). The ML diagnostics engine 1316 computes the distance between the run-time N-tuple and each of the J N-tuples in the performance labeled data frame 2504 as follows:

$$d ( j , rt ) = \sqrt{{\sum }_{n = 1}^{N} {( {m}_{jn} - {m}_{n}^{rt} )}^{2}} \qquad ( 6 )$$

The distances are ranked from smallest to largest. The state of the application is classified as low, medium, or high performance based on the low, medium, or high performance assigned to the cluster with the largest number of K nearest neighbor N-tuples to the runtime N-tuple.

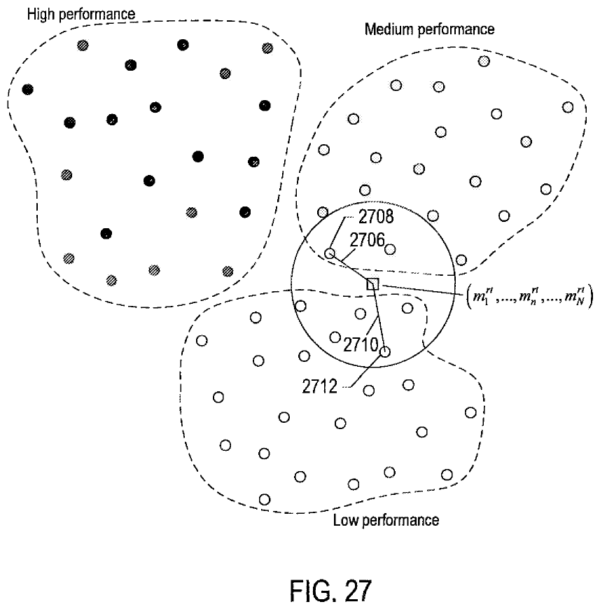

FIG. 27 shows an example of classifying a runtime N-tuple based on the three clusters of N-tuples in the performance labeled data frame. As shown in FIG. 27, the clusters described above with reference to FIG. 23 have been classified as low performance, medium performance, and high performance. Square point 2702 represents the runtime N-tuple. A distance as described above with reference to Equation (6) is computed between the runtime N-tuple 2702 and each of the N-tuples in the performance labeled data frame. In this example, K is set equal to 7. Circle 2704 is centered on the runtime N-tuple 2702 and encloses the 7 nearest N-tuples of the clusters. For example, line 2706 represents the distance between the runtime N-tuple 2702 and the N-tuple 2708, and line 2710 represents the distance between the runtime N-tuple 2702 and the N-tuple 2712. The ML diagnostics engine 1316 counts the number of nearest neighbor runtime distributions of each cluster. In this example, the medium performance cluster has only two nearest neighbor N-tuples and the low performance cluster has five nearest neighbor N-tuples. As a result, the ML diagnostics engine 1316 labels the runtime N-tuple as low performance. The low performance state of the application is displayed in a GUI, thereby informing a systems administrator or application owner of the state of the application.

The ML diagnostics engine 1316 uses machine learning to train a decision-tree model for constructing rules comprising conditions on KPIs that can be utilized for root cause analysis. The decision-tree model is trained using the performance labeled data frame. Techniques for training a decision-tree model include repeated incremental pruning to produce error reduction (“RIPPER”) rule learning as described in “Fast effective rule induction.” by W. Cohen, Proc. Twelfth International Conference on Machine Learning, Tahoe City, California, July 9-12, pp. 115-123, 1995, which is herein incorporated by reference. In another implementation, CN2 rule learning can be used to construct rules as describe in Foundation of Rule Learning, by J. Farnkranz, D. Gamberger. N. Lavrac, Springer-Verlag, 2012, which is herein incorporated by reference.

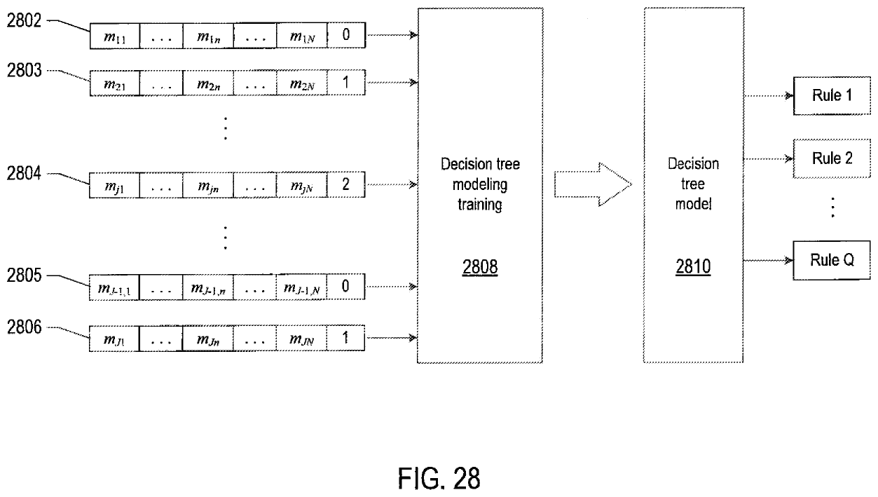

FIG. 28 shows an example of a decision tree technique used to generate a decision-tree model based on the labeled N-tuples of the performance labeled data frame represented by a data sets 2802-2806. Block 2808 represents the computational operations carried out by one of the decision tree techniques. As shown in FIG. 28, the N-tuples and corresponding KPI labels are input to the decision tree model training 2808 to train a decision-tree model 2810. The decision-tree model 2810 produces a set of rules, identified as Rule1, Rule2, . . . , RuleQ, for identifying conditions on a subset of KPIs that predict a root cause of a performance problem with the application or explain and characterize the respective performance category.

For the sake of simplicity, the decision-tree model 2810 is represented as a graph in which each node represents a condition of a normalized metric value. Each branch of the trained decision tree represents an outcome of a condition (e.g., a test threshold value) in with a normalized metric value is compared to a threshold. The threshold values are determined in the decision-tree model training process 2808. Each leaf corresponds to a performance label. Paths of the decision-tree model correspond to rules that identify one or more KPIs that are associated with root causes of a performance problem with the application.

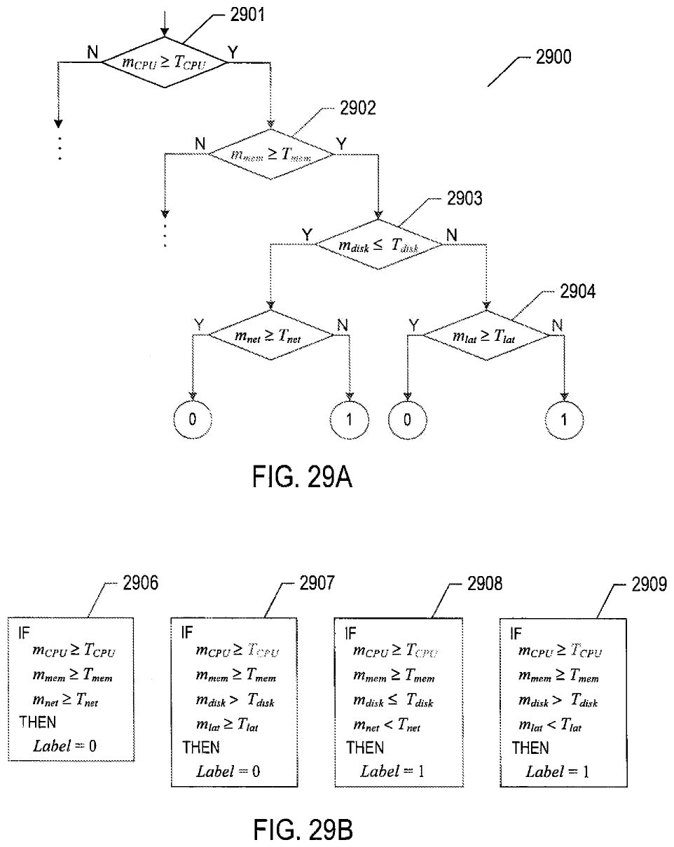

FIG. 29A show an example small portion of a decision-tree model 2900 obtained from a decision-tree model training process. For the sake of simplicity, only five different KPIs denoted by m_{CPU}, mₘₑₘ, m_{disk}, mₙₑₜ, and mₗₐₜ are used to create rules. The root node can be a test for an important KPI with the largest entropy. At root node 2901, when the normalized CPU, m_{CPU}, is greater than the CPU threshold T_{CPU}, the flow proceeds to node 2902 and the normalized memory, mₘₑₘ, is compared to the memory threshold T_{CPU}. FIG. 29B shows examples of rules 2906-2909 that correspond to paths in the decision-tree model 2900. For example, the inequalities at the nodes 2901-2904 form a rule where if normalized metric values m_{CPU}, mₘₑₘ, m_{disk}, and mₗₐₜ satisfy the corresponding conditional statements m_{CPU}≥T_{CPU}, mₘₑₘ≥Tₘₑₘ, m_{disk}>T_{disk}, and mₗₐₜ<Tₗₐₜ then the application is predicted to have a medium performance. The normalized metric values can be used to identify a root cause of the low performance and used to adjust resources utilized by the application to improve performance of the application. For example, when the runtime normalized metric values of the CPU, memory, and disk exceed corresponding thresholds, the CPU, memory, and disk space allocated to the application can be increased. Alternatively, the application may be migrated to a different cluster of nodes with a larger amount of CPU, memory, and disk space available to execute the tasks of the application.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An adjusted group execution framework comprising:
an instruction loader that loads and parses an instruction file, the instruction file comprises actions and operations that describe running tasks of a monolithic application on a cluster of nodes;
an executor that distributes and runs the tasks of the application on the nodes of the cluster in accordance with the actions and operations of the instruction file; and
a machine learning diagnostic engine that collects key performance indicators (“KPI”) of the application to train a machine learning model that determines a performance state of the application based on runtime metric values of the KPIs.

2. The adjusted group execution framework of claim 1 further comprises a state machine that maintains a record of states and status of operations and actions executed by the executor in a database using a standard query language.

3. The adjusted group execution framework of claim 1 wherein the executor runs the tasks of the application sequential at nodes of the cluster and in parallel across the nodes in response to the operations of the instruction file.

4. The adjusted group execution framework of claim 1 wherein the executor runs the tasks of the application in parallel in each node of the cluster and sequentially across the nodes in response to the operations of the instruction file.

5. The adjusted group execution framework of claim 1 wherein the machine learning diagnostic engine is a component of an agent worker that checks performance status of the actions and operations performed by the executor.

6. The adjusted group execution framework of claim 1 wherein, for each KPI of an action or operation of the tasks of the application, the machine learning diagnostic engine performs operations comprising:
partitions a historical time period into subintervals;
averages metric values of the KPI in each subinterval to obtain an average metric value for each subinterval;
normalizes the average metric values of each subinterval to obtain a normalized metric value for each subinterval;
determines two or more clusters of the normalized metric values, each cluster corresponding to a different performance state of the application;
collects and normalizes runtime metric values of the application to obtain normalized metric values; and
determines the performance state of the application based on which cluster contains the largest number of normalized metric values to the runtime normalized metric values.

7. Apparatus comprising:
an instruction loader for loading and parsing an instruction file, the instruction file comprises actions and operations that describe running tasks of a monolithic application on a cluster of nodes;
an executor for distributing and running the tasks of the application on the nodes of the cluster in accordance with the actions and operations of the instruction file; and
a machine learning diagnostic engine for collecting key performance indicators (“KPI”) of the application and training a machine learning model that determines a performance state of the application based on runtime metric values of the KPIs.

8. The apparatus of claim 7 further comprises a state machine for maintaining a record of states and status of operations and actions executed by the executor in a database using a standard query language.

9. The apparatus of claim 7 wherein the executor runs the tasks of the application sequential at nodes of the cluster and in parallel across the nodes in response to the operations of the instruction file.

10. The apparatus of claim 1 wherein the executor runs the tasks of the application in parallel in each node of the cluster and sequentially across the nodes in response to the operations of the instruction file.

11. The apparatus of claim 7 wherein the machine learning diagnostic engine is a component of an agent worker that checks performance status of the actions and operations performed by the executor.

12. The apparatus of claim 7 wherein, for each KPI of an action or operation of the tasks of the application, the machine learning diagnostic engine performs operations comprising:
partitions a historical time period into subintervals;
averages metric values of the KPI in each subinterval to obtain an average metric value for each subinterval;
normalizes the average metric values of each subinterval to obtain a normalized metric value for each subinterval;
determines two or more clusters of the normalized metric values, each cluster corresponding to a different performance state of the application;
collects and normalizes runtime metric values of the application to obtain normalized metric values; and
determines the performance state of the application based on which cluster contains the largest number of normalized metric values to the runtime normalized metric values.
